(19) United States
(12) Patent Application Publication
(10) Pub. No.: US 2006/0258221 A1
(43) Pub. Date: Nov. 16, 2006

(54) Connector apparatus and method

(76) Inventor: Mark L. Welker, (US)

Correspondence Address: ALTON W. PAYNE, 5508 GRAND LAKE, HOUSTON, TX, 77081, US

(21) Appl. No.: 11/400,461

(22) Filed: Apr. 7, 2006

Related U.S. Application Data
(60) Provisional application No. 60/669,587, filed on Apr. 7, 2005.

(51) Int. Cl. H01R 9/03

(52) U.S. Cl. 439/610

(57) ABSTRACT

The present invention relates generally to the field of connectors. The invention relates to a novel connector and method for connecting electrical wires and the like. More specifically, the present invention relates to an apparatus and method that provides for the easy and quick connection and disconnection of wires.

### CROSS REFERENCE TO RELATED APPLICATION

The present application is a continuation-in-part application of the application of Mark L. Welker, U.S. Ser. No. 60/669,587, filed Apr. 7, 2005, entitled CONECTOR APPARATUS AND METHOD.

### FIELD OF THE INVENTION

The present invention relates generally to the field of connectors. More particularly, the present invention relates to an apparatus and method in which the connector is attached to the pre-existing or new wiring conduit. The connector apparatus and method can be easily attached to the conduit coupling by having a portal at the power source entry point of the connector apparatus which is easily attached to the common conduit coupling.

### BACKGROUND OF THE INVENTION

Typically, in light fixtures, electrical apparatuses or other associated devices (“the electrical device”), the method of wiring the electrical device to the power source is accomplished by the conventional method of “hard” wiring using “wire nut” connectors at the point of connection. Wiring is usually encased in a protective metal pipe referred to as “conduit” or a flexible metal sheath referred to as “flexible conduit”. The conduit or flexible conduit is attached to the power source and the electrical device with a conduit coupling (“coupling”) attached at both ends. The coupling attaches to an electrical junction box at the power source and at the pre-established wiring knockout of the electrical device permitting the encased wiring to be protected and safely connected at both ends.

There exists a large market for an electrical connector to be readily installed and adapted to the coupling of the conduit or flexible conduit to include but not be limited to a method for: (1) quicker installation of the electrical device to the power source; (2) safer disconnection of the electrical device from the power source; (3) safer disconnection of the electrical device from the electrical power inlet.

Therefore, there is a need for an electrical connector and method having enhanced flexibility with respect to existing couplings and wiring methods of electrical systems.

It would therefore be useful to provide an electrical connector that can be adapted to, but not be limited to, light fixtures, wall outlet sockets, on and off power switches, HVAC equipment and other electrical devices when local and national electrical codes would accept such electrical connector.

A feature of the present invention would be the method in which the electrical connector is attached to the conduit (FIG. 1A). Through the use of a threaded portal at the power source entry point (FIGS. 2, 3 & 4), the electrical connector can be easily attached to the coupling connected to either a conduit or flexible conduit (FIG. 1A).

Yet another feature of the present invention would allow the electrical connector to be fitted with metal terminals with self-tapping features (FIG. 1E) enabling the incoming wires to be placed in designated slots of the metal terminals (FIGS. 3 & 4) eliminating the need for pre-stripping the wire endings for metal exposure.

Another feature of the present invention would be for the electrical connector to be designed in at least two mated parts (FIGS. 3 & 4) enabling the electrical connector to be easily fastened to the wiring (FIG. 1A). This feature would also allow the electrical connector to be installed without the need of special tooling or specialty training of the installer. A working knowledge and understanding of electricity would be necessary.

Yet another feature of the present invention would be for the electrical connector (FIG. 1A) to be designed to include a receiver apparatus (FIG. 1D) to be fastened to the two mated parts (FIG. 27).

Another feature of the present invention would be for the receiver apparatus (FIG. 1D) to be designed to include a quick release latch (FIGS. 5 & 6) enabling the receiver apparatus to be easily disconnected from the electrical connector (FIG. 1A).

Yet another device for use in attaching the electrical connector (FIG. 1A) to the flexible conduit (FIG. 27) would be to design an articulating coupling (FIG. 36). The articulating coupling would allow the flexible conduit to be attached to the electrical connector and enable the articulating coupling to both rotate and pivot to accommodate the best positioning of the electrical device while minimizing any effect of disengaging the electrical device from the receiver apparatus.

Yet another device for use in attaching an electrical connector (FIG. 1A) or multiple electrical connectors to the power source would be to design a “junction box” or “gang box” fitted with multiple receiver apparatuses (FIGS. 34, 33 & 28) or a single receiver apparatus (FIG. 35).

Another method for attaching an electrical connector (FIG. 1A) or multiple electrical connectors to the power source would be through the use of a “junction box” or “gang box” fitted with multiple receiver apparatuses (FIGS. 34, 33 & 28) or a single receiver apparatus (FIG. 35).

Yet another method for connecting the electrical connector, attached to a coupling and conduit (FIG. 1A), from a remote location to the power source would be through the use of a remote access header (FIG. 31). By installing a receiver apparatus (FIG. 1D) into a remote electrical receptacle box (FIG. 32) affixed to a wall header or other structure (FIG. 30), the electrical connector can easily be attached to the receiver apparatus (FIG. 30). Mounting of the electrical receptacle box affixed to the wall header or similar structure would enable other electrical devices to be attached to the receiver apparatus as shown in (FIG. 30).

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### BRIEF DESCRIPTION OF THE DRAWINGS

The accompanying drawings which are incorporated in and constitute a part of the specification, illustrate preferred embodiments of the invention and together with the general description of the invention given above and the detailed description of the preferred embodiment given below, serve to explain the principles of the invention.

FIG. 1A is a perspective view of a preferred embodiment of the connector apparatus of the present invention connected to a flexible cable.

FIG. 1B is a perspective view of a preferred embodiment of the bottom of the connector apparatus of the present invention.

FIG. 1C is a perspective view of a preferred embodiment of the top of the connector apparatus of the present invention.

FIG. 1D is a perspective view of a preferred embodiment of the connector apparatus of the present invention mountable to a fixture.

FIG. 1E is a perspective view of a preferred embodiment of the metal insert terminals of the connector apparatus of the present invention.

FIG. 2 is a perspective view of a preferred embodiment of the connector apparatus of the present invention illustrating a threaded adapter.

FIG. 3 is a perspective, break-away view of a preferred embodiment of the connector apparatus of the present invention illustrating a threaded adapter as illustrated in FIG. 2.

FIG. 4 is a perspective, break-away view of a preferred embodiment of the connector apparatus of the present invention illustrating a threaded adapter as illustrated in FIGS. 2 and 3.

FIG. 5 is a perspective view of a preferred embodiment of the engaging end of the connector apparatus of the present invention.

FIG. 6 is a perspective view of a preferred embodiment of the engaging end of the connector apparatus of the present invention as illustrated in FIG. 5.

FIG. 7 is a plan, top view of a preferred embodiment of the engaging end of the connector apparatus of the present invention.

FIG. 8 is a plan, back view of a preferred embodiment of the engaging end of the connector apparatus of the present invention.

FIG. 9 is a plan, side view of a preferred embodiment of the engaging end of the connector apparatus of the present invention.

FIG. 10 is a small scale, plan view of a preferred embodiment of the engaging end of the connector apparatus of the present invention.

FIG. 11 is a side view, perspective of a preferred embodiment of the engaging end of the connector apparatus of the present invention.

FIG. 12 is a perspective view of a preferred embodiment of the components of the connector apparatus of the present invention.

FIG. 13 is a side view, perspective of a preferred embodiment of the engaging end of the connector apparatus of the present invention.

FIG. 14 is a perspective view of a preferred embodiment of the connector apparatus of the present invention.

FIG. 15 is a perspective view of a preferred embodiment of the connector apparatus of the present invention indicating what portion of the connector is inside the fixture and what portion is outside the connector.

FIG. 16 is a perspective view of a preferred embodiment of the connector apparatus of the present invention further illustrating the retention clips.

FIG. 17 is a perspective view of a preferred embodiment of the connector apparatus of the present invention indicating what portion of the connector is recessed inside of the fixture.

FIG. 18 is a perspective view of a preferred embodiment of the connector apparatus of the present invention indicating what portion of the connector is exposed outside of the fixture.

FIG. 19 is a perspective view of a preferred embodiment of the connector apparatus of the present invention as related to a fixture.

FIG. 20 is a perspective view of a preferred embodiment of the connector apparatus of the present invention extending from a fixture.

FIG. 21 is a perspective view of a preferred embodiment of the connector apparatus of the present invention extending from a fixture.

FIG. 22 is a perspective view of a preferred embodiment of the connector apparatus of the present invention with the fixture electrical plug and wiring connected to the fixture electronics.

FIG. 23 is a perspective view of a preferred embodiment of the connector apparatus of the present invention associated with the fixture in a disengaged mode.

FIG. 24 is a perspective view of a preferred embodiment of the connector apparatus of the present invention associated with the fixture in a engaged mode.

FIG. 25 is a close-up, perspective view of a preferred embodiment of the connector apparatus of the present invention associated with the fixture in a engaged mode.

FIG. 26 is a perspective view of a preferred embodiment of the connector apparatus of the present invention associated with the fixture in a ceiling.

FIG. 27 is a perspective view of a preferred embodiment of the connector apparatus of the present invention with the fixture electrical plug and wiring connected to the fixture electronics.

FIG. 28 is a perspective view of a preferred embodiment of the gang box apparatus of the present invention.

FIG. 29 is another perspective view of a preferred embodiment of the gang box apparatus of the present invention.

FIG. 30 is a perspective, break-away view of a preferred embodiment of the gang box apparatus of the present invention with a wall header or a single outlet wall mount.

FIG. 31 is a perspective, break-away view of a preferred embodiment of the gang box apparatus of the present invention with a mounted box or a single outlet wall mount.

FIG. 32 is a perspective, break-away view of a preferred embodiment of a portion of the gang box apparatus of the present invention.

FIG. 33 is a perspective view of a preferred embodiment of the gang/junction box apparatus of the present invention.

FIG. 34 is a perspective view of another preferred embodiment of the gang/junction box apparatus of the present invention.

FIG. 35 is a perspective view of another preferred embodiment of the gang/junction box apparatus of the present invention.

FIG. 36 is a perspective, break-away view of a preferred embodiment of the articulating coupling apparatus of the present invention.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

### DETAILED DESCRIPTION OF THE PREFERRED EMBODIMENTS

The above general description and the following detailed description are merely illustrative of the generic invention, and additional modes, advantages, and particulars of this invention will be readily suggested to those skilled in the art without departing from the spirit and scope of the invention.

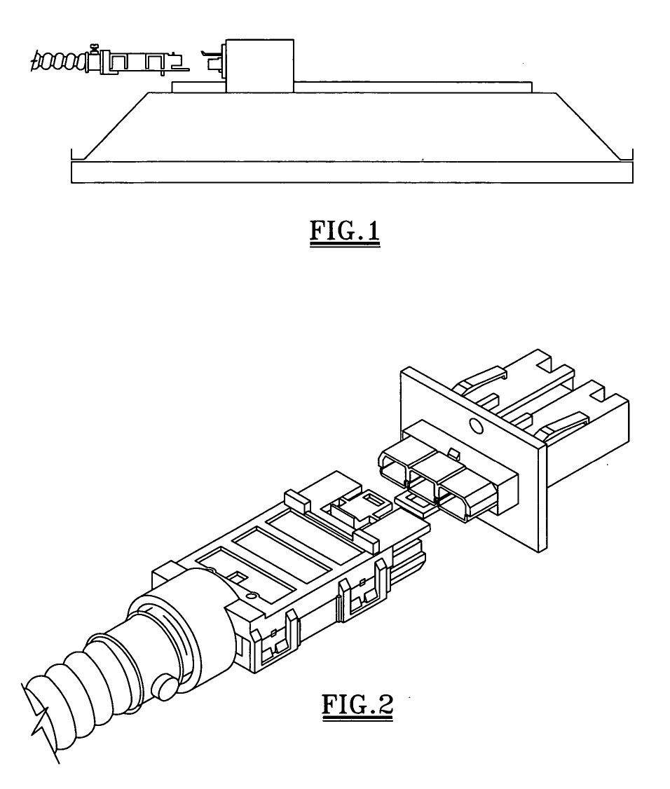

FIG. 1A is a perspective view of a preferred embodiment of the connector apparatus of the present invention connected to a flexible cable.

FIG. 1B is a perspective view of a preferred embodiment of the bottom of the connector apparatus of the present invention.

FIG. 1C is a perspective view of a preferred embodiment of the top of the connector apparatus of the present invention.

FIG. 1D is a perspective view of a preferred embodiment of the connector apparatus of the present invention mountable to a fixture.

FIG. 1E is a perspective view of a preferred embodiment of the metal insert terminals of the connector apparatus of the present invention.

FIG. 2 is a perspective view of a preferred embodiment of the connector apparatus of the present invention illustrating a threaded adapter.

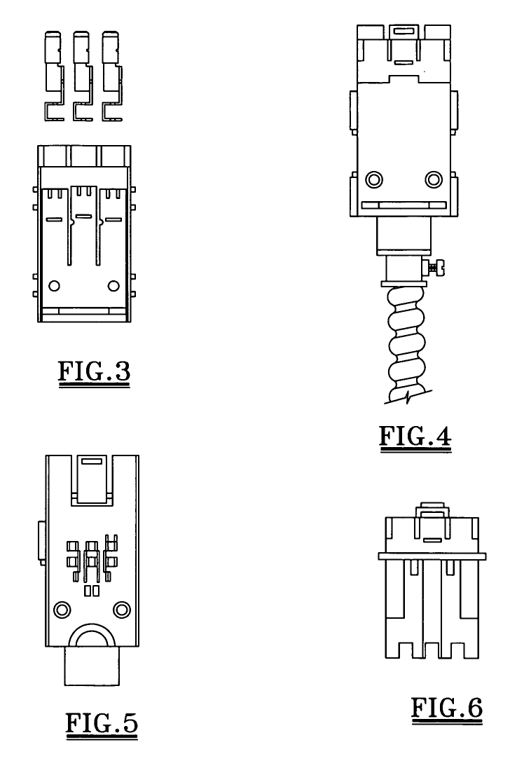

FIG. 3 is a perspective, break-away view of a preferred embodiment of the connector apparatus of the present invention illustrating a threaded adapter as illustrated in FIG. 2.

FIG. 4 is a perspective, break-away view of a preferred embodiment of the connector apparatus of the present invention illustrating a threaded adapter as illustrated in FIGS. 2 and 3.

FIG. 5 is a perspective view of a preferred embodiment of the engaging end of the connector apparatus of the present invention.

FIG. 6 is a perspective view of a preferred embodiment of the engaging end of the connector apparatus of the present invention as illustrated in FIG. 5.

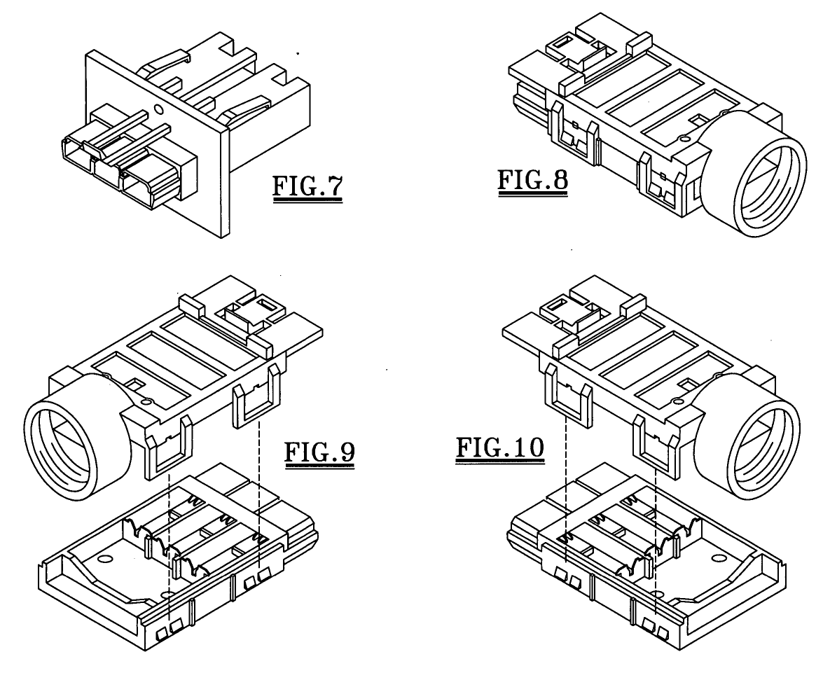

FIG. 7 is a plan, top view of a preferred embodiment of the engaging end of the connector apparatus of the present invention.

FIG. 8 is a plan, back view of a preferred embodiment of the engaging end of the connector apparatus of the present invention.

FIG. 9 is a plan, side view of a preferred embodiment of the engaging end of the connector apparatus of the present invention.

FIG. 10 is a small scale, plan view of a preferred embodiment of the engaging end of the connector apparatus of the present invention.

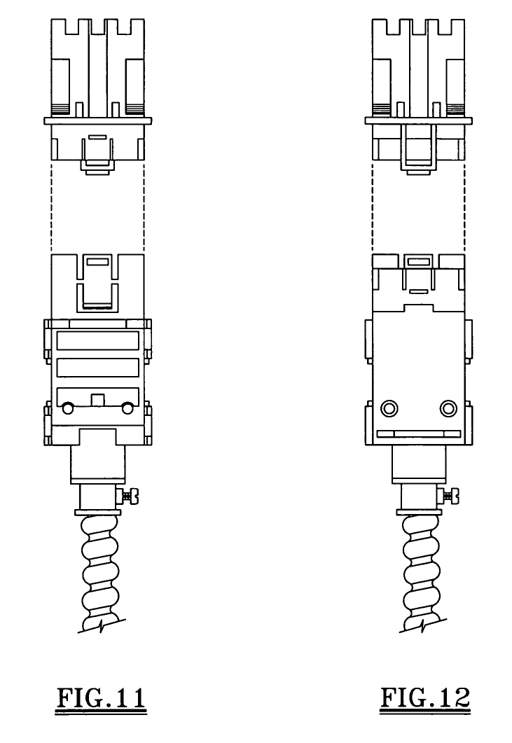

FIG. 11 is a side view, perspective of a preferred embodiment of the engaging end of the connector apparatus of the present invention.

FIG. 12 is a perspective view of a preferred embodiment of the components of the connector apparatus of the present invention.

FIG. 13 is a side view, perspective of a preferred embodiment of the engaging end of the connector apparatus of the present invention.

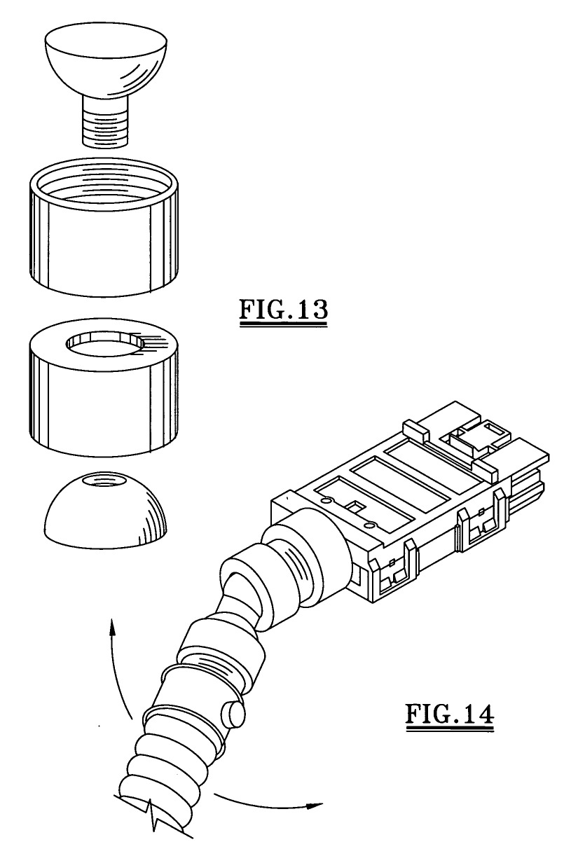

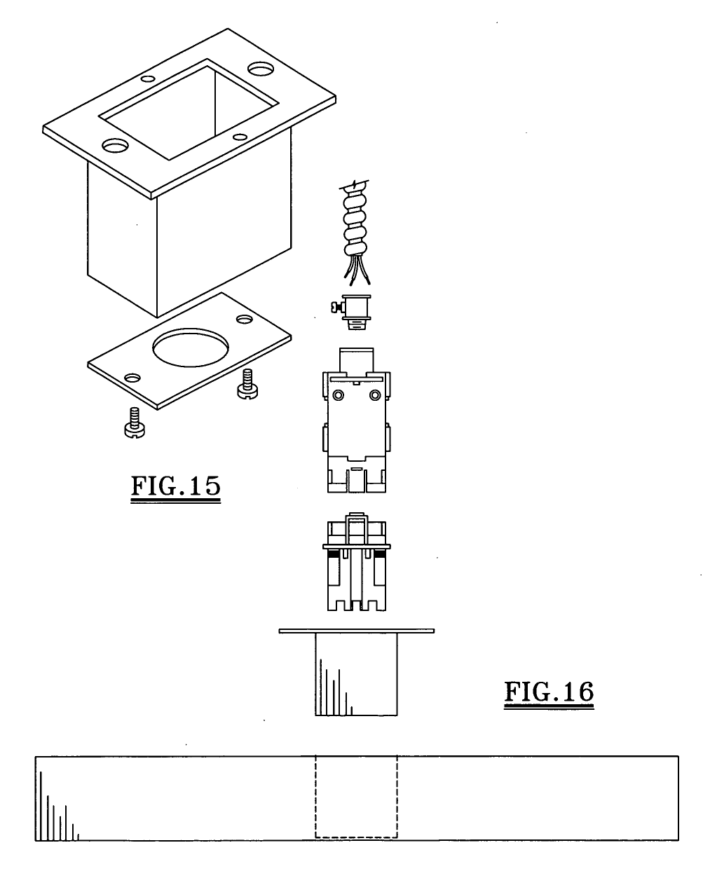

FIG. 14 is a perspective view of a preferred embodiment of the connector apparatus of the present invention.

FIG. 15 is a perspective view of a preferred embodiment of the connector apparatus of the present invention indicating what portion of the connector is inside the fixture and what portion is outside the connector.

FIG. 16 is a perspective view of a preferred embodiment of the connector apparatus of the present invention further illustrating the retention clips.

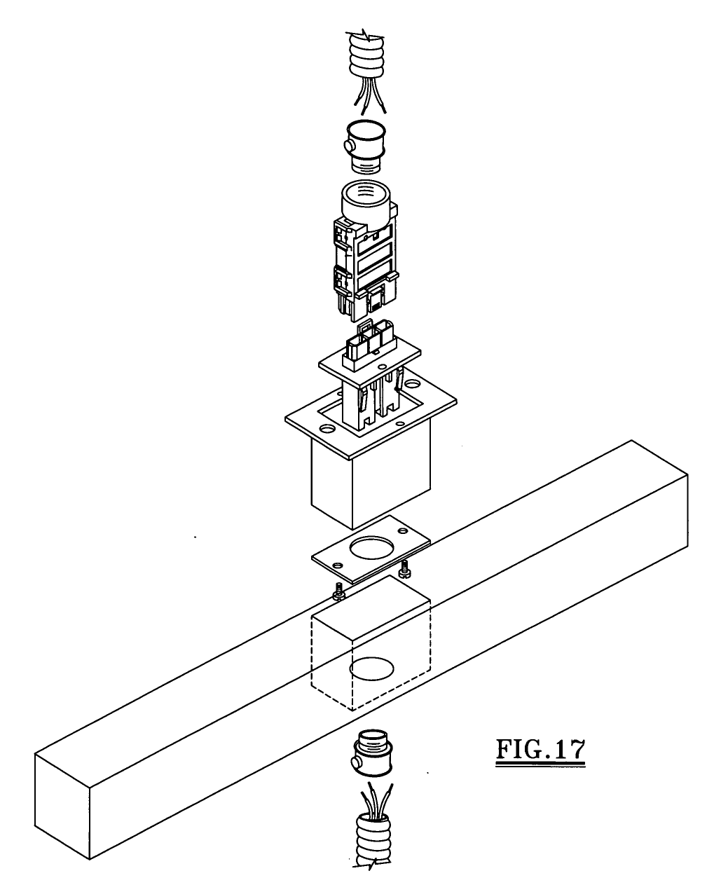

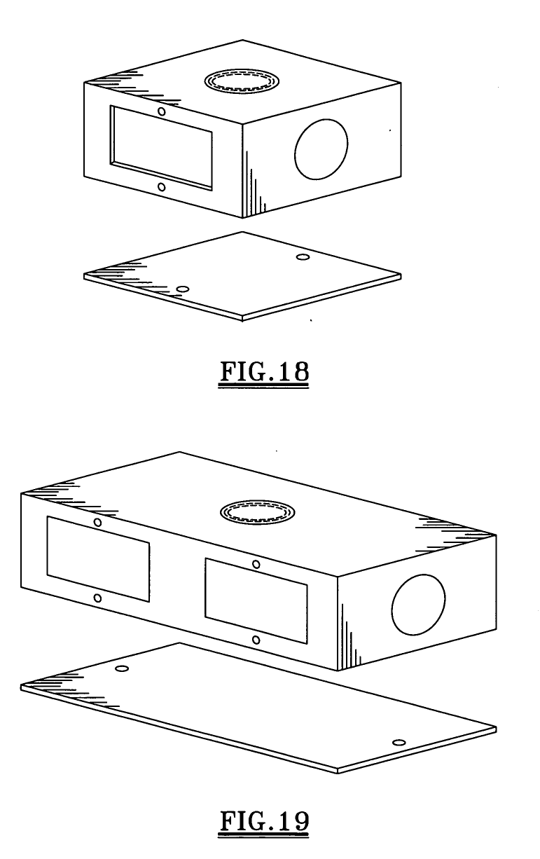

FIG. 17 is a perspective view of a preferred embodiment of the connector apparatus of the present invention indicating what portion of the connector is recessed inside of the fixture.

FIG. 18 is a perspective view of a preferred embodiment of the connector apparatus of the present invention indicating what portion of the connector is exposed outside of the fixture.

FIG. 19 is a perspective view of a preferred embodiment of the connector apparatus of the present invention as related to a fixture.

FIG. 20 is a perspective view of a preferred embodiment of the connector apparatus of the present invention extending from a fixture.

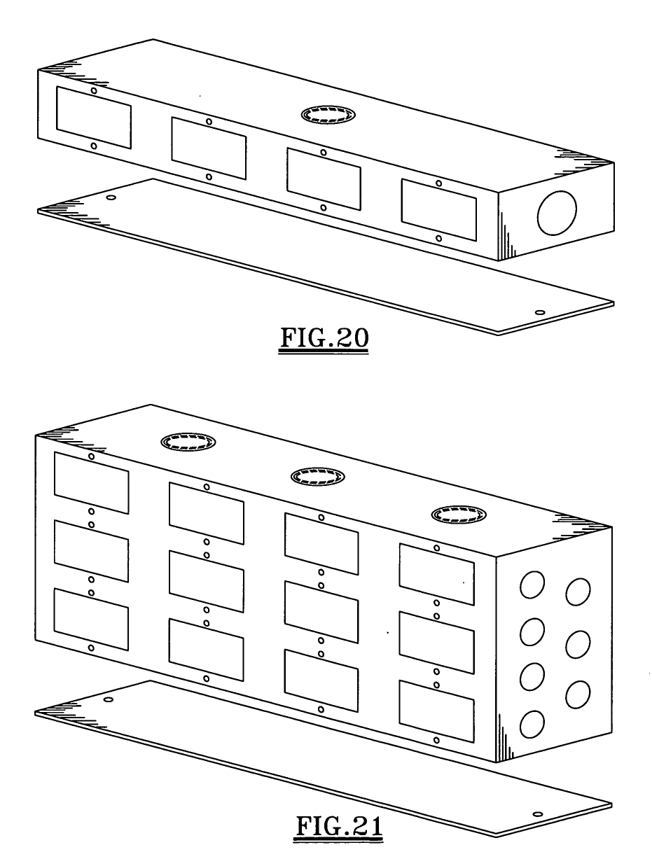

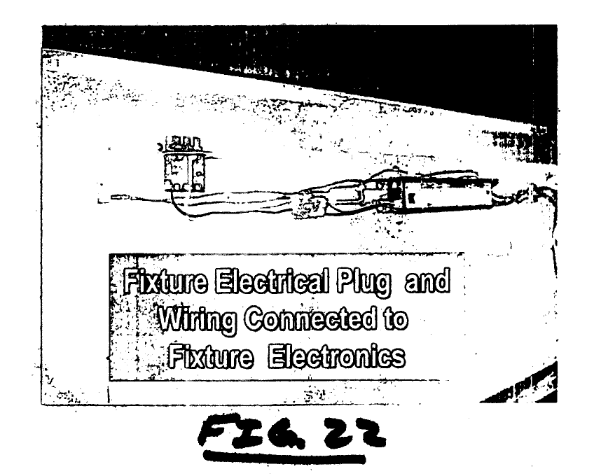

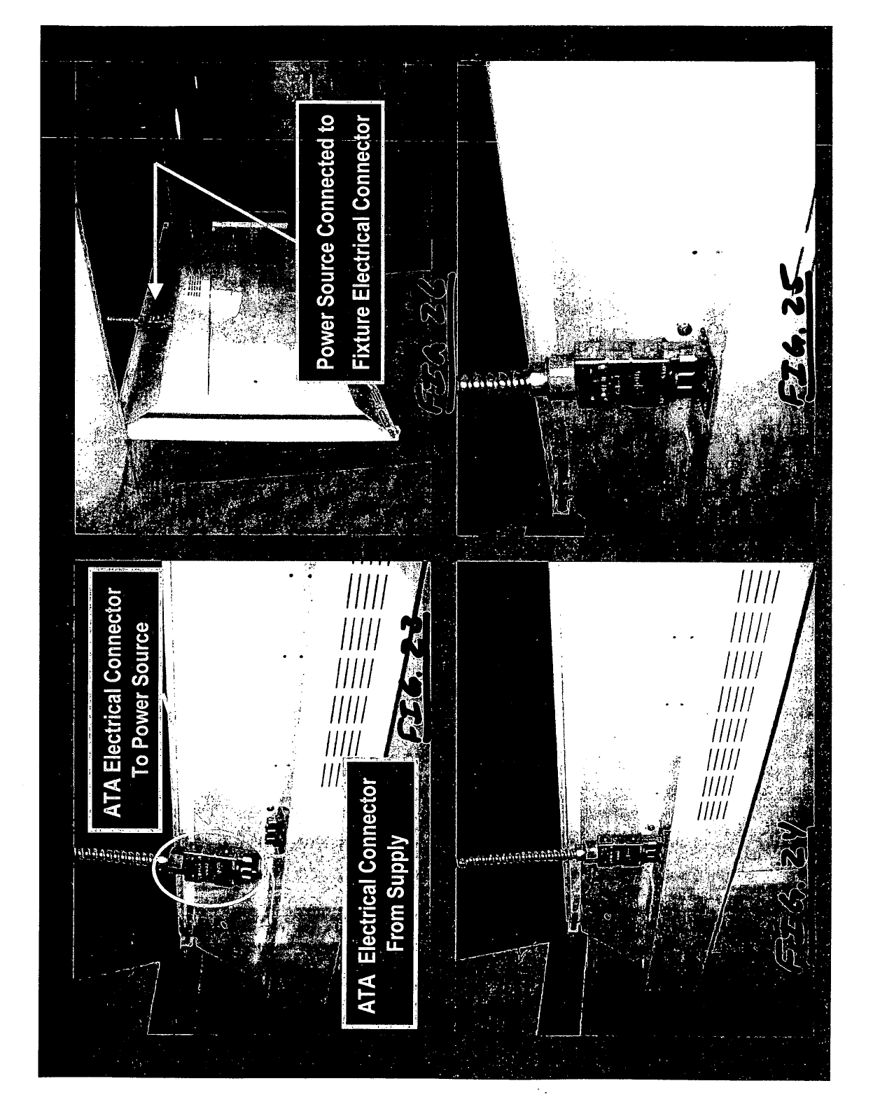

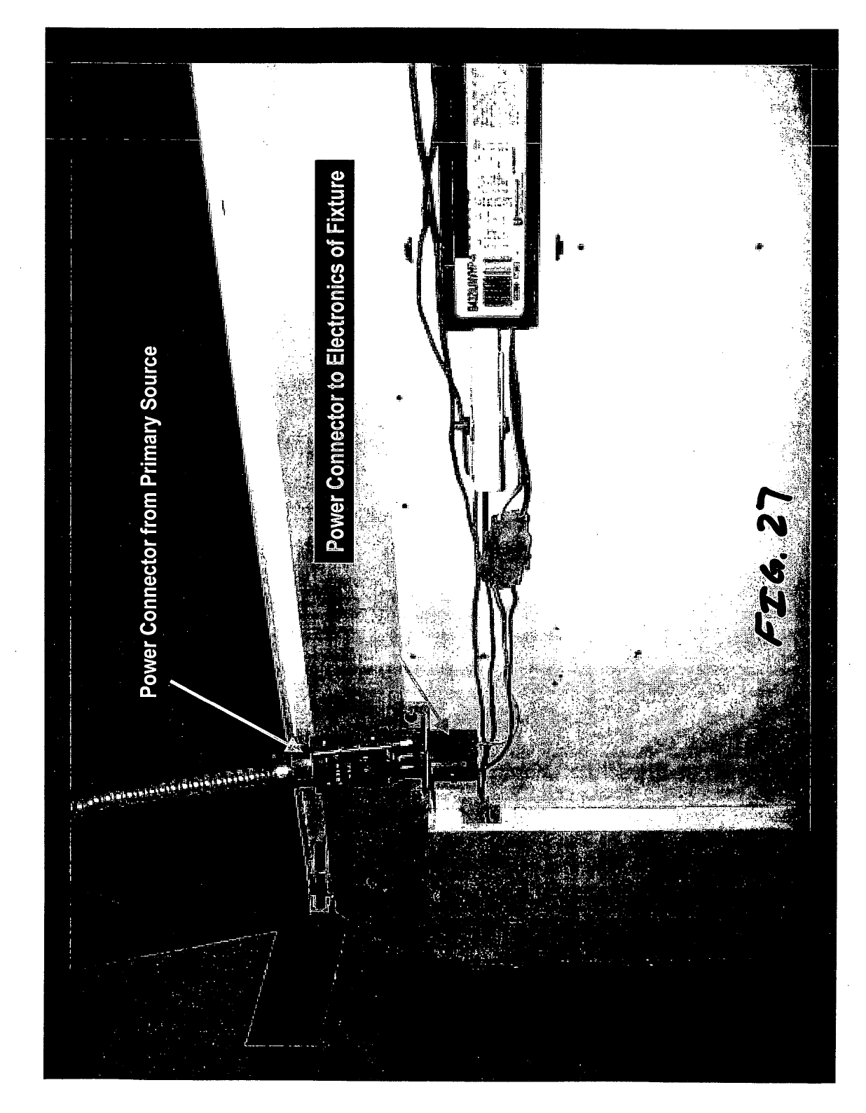

FIG. 21 is a perspective view of a preferred embodiment of the connector apparatus of the present invention extending from a fixture.

FIG. 22 is a perspective view of a preferred embodiment of the connector apparatus of the present invention with the fixture electrical plug and wiring connected to the fixture electronics.

FIG. 23 is a perspective view of a preferred embodiment of the connector apparatus of the present invention associated with the fixture in a disengaged mode.

FIG. 24 is a perspective view of a preferred embodiment of the connector apparatus of the present invention associated with the fixture in a engaged mode.

FIG. 25 is a close-up, perspective view of a preferred embodiment of the connector apparatus of the present invention associated with the fixture in a engaged mode.

FIG. 26 is a perspective view of a preferred embodiment of the connector apparatus of the present invention associated with the fixture in a ceiling.

FIG. 27 is a perspective view of a preferred embodiment of the connector apparatus of the present invention with the fixture electrical plug and wiring connected to the fixture electronics.

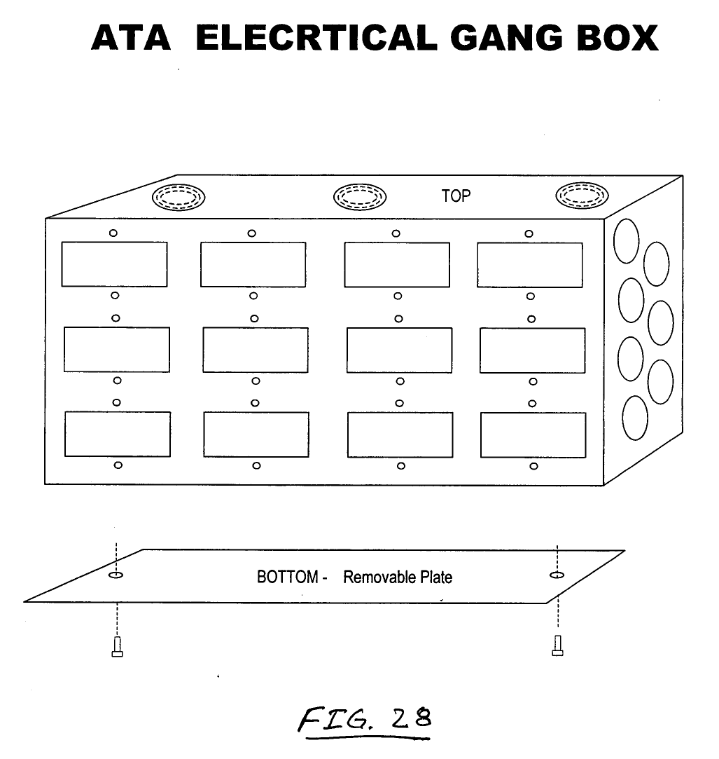

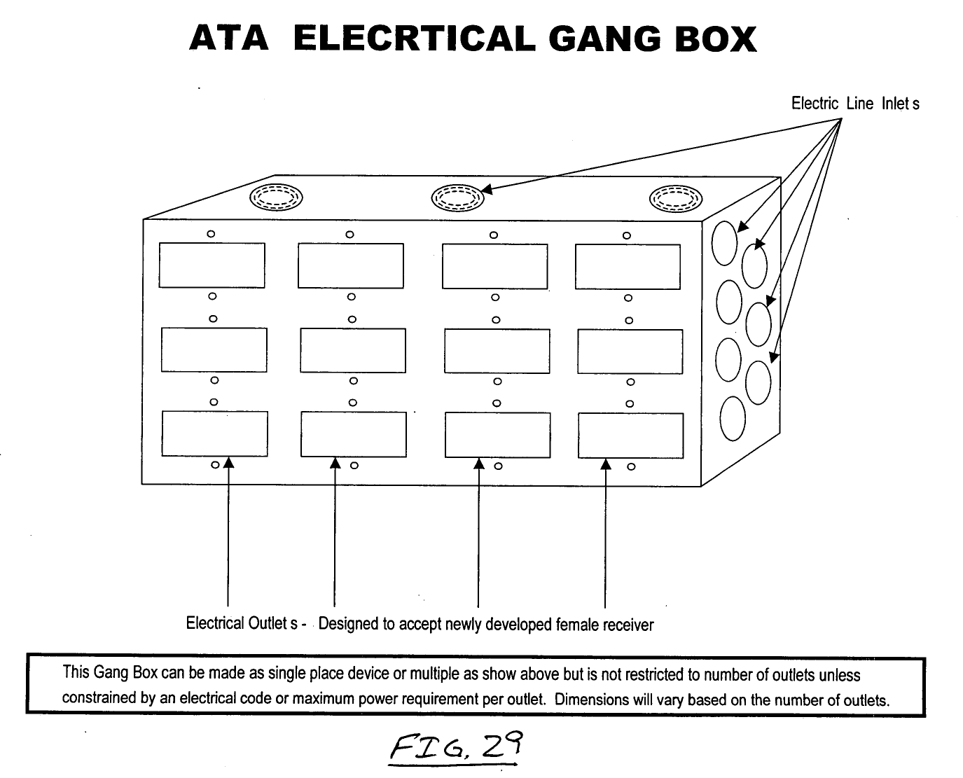

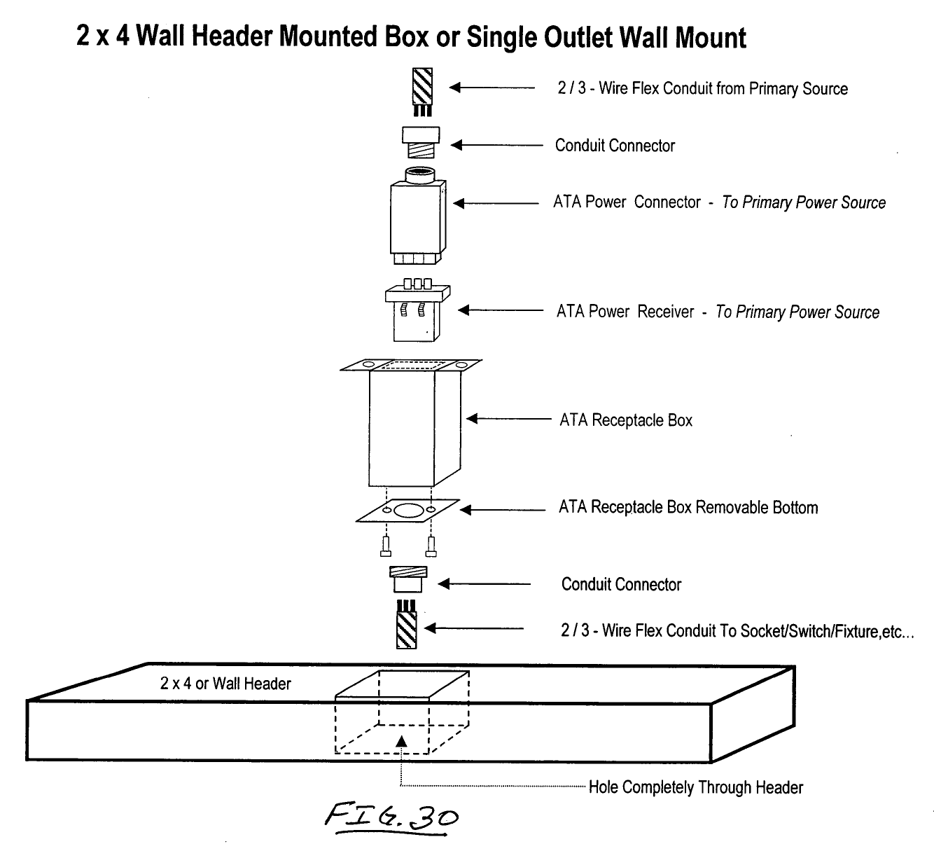

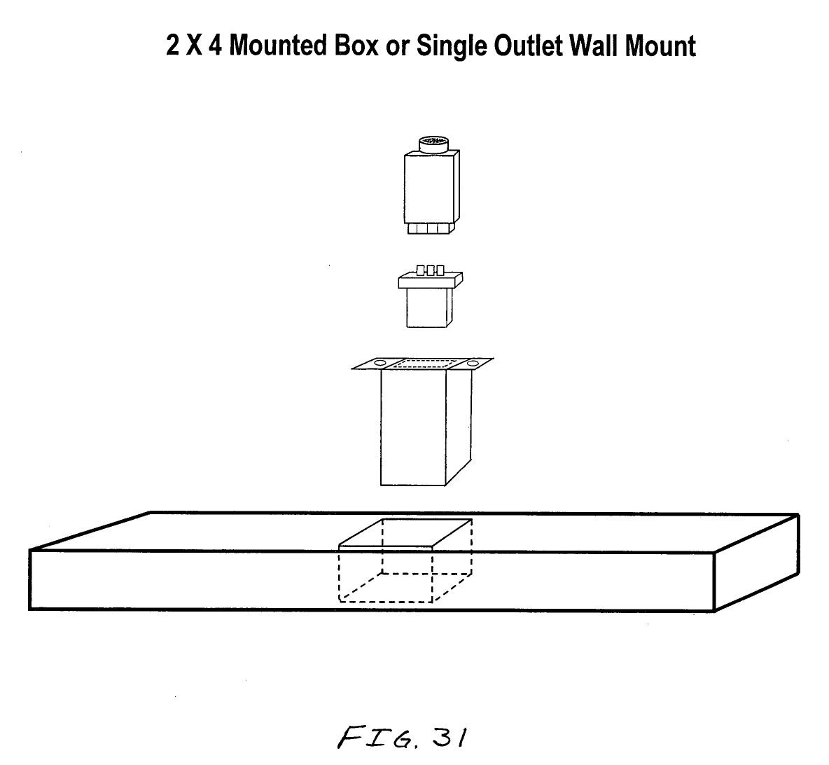

FIG. 28 is a perspective view of a preferred embodiment of the gang box apparatus of the present invention.

FIG. 29 is another perspective view of a preferred embodiment of the gang box apparatus of the present invention.

FIG. 30 is a perspective, break-away view of a preferred embodiment of the gang box apparatus of the present invention with a wall header or a single outlet wall mount.

FIG. 31 is a perspective, break-away view of a preferred embodiment of the gang box apparatus of the present invention with a mounted box or a single outlet wall mount.

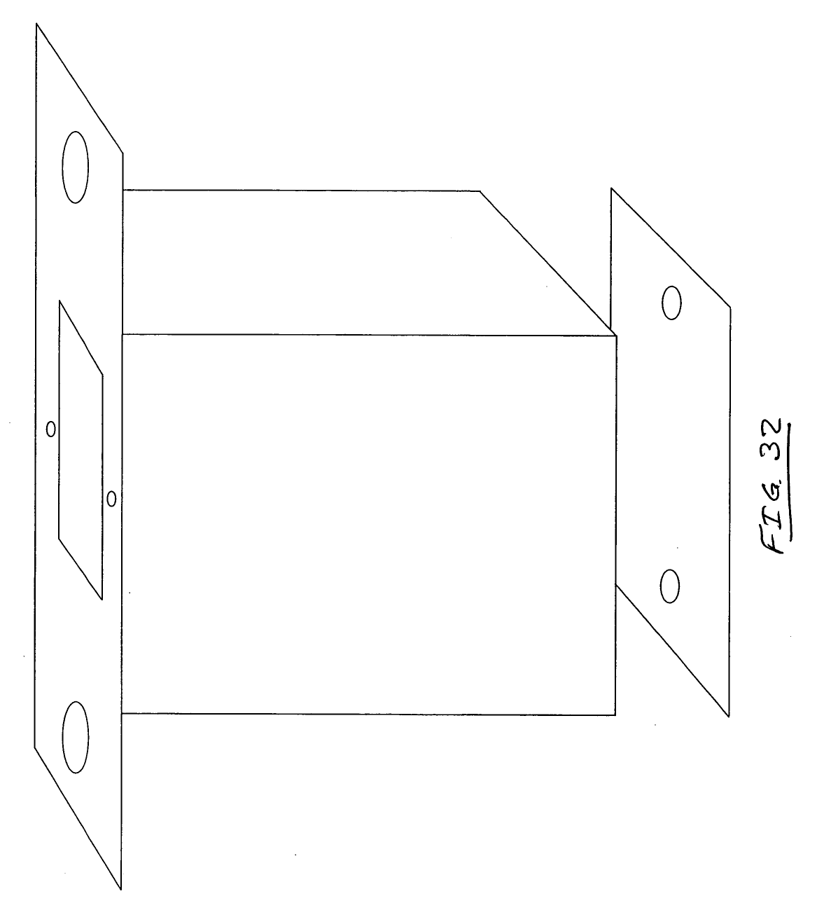

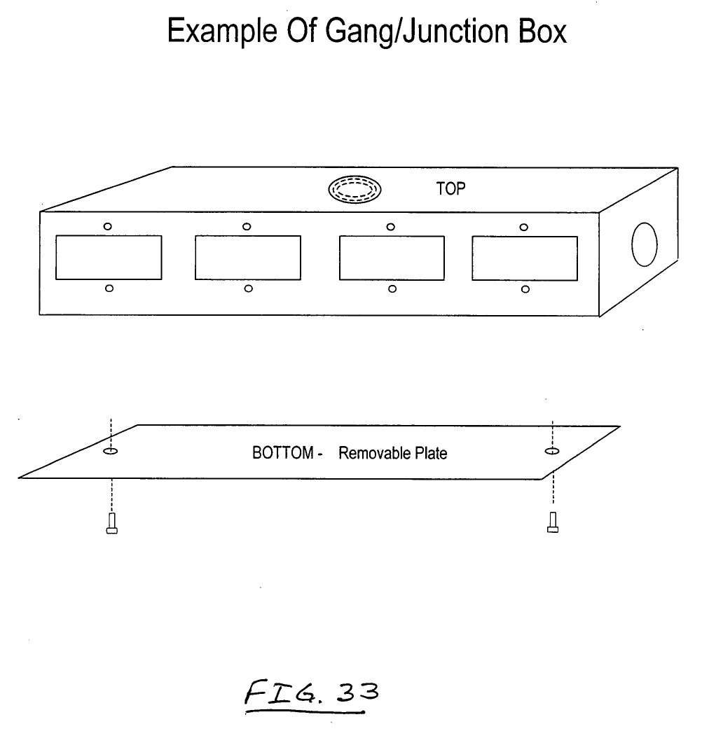

FIG. 32 is a perspective, break-away view of a preferred embodiment of a portion of the gang box apparatus of the present invention.

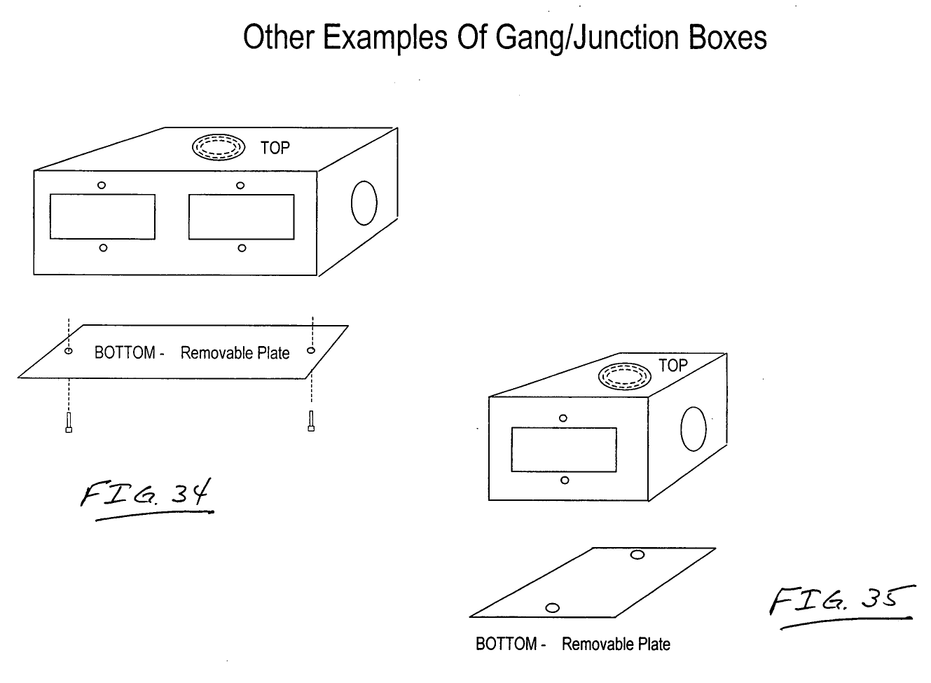

FIG. 33 is a perspective view of a preferred embodiment of the gang/junction box apparatus of the present invention.

FIG. 34 is a perspective view of another preferred embodiment of the gang/junction box apparatus of the present invention.

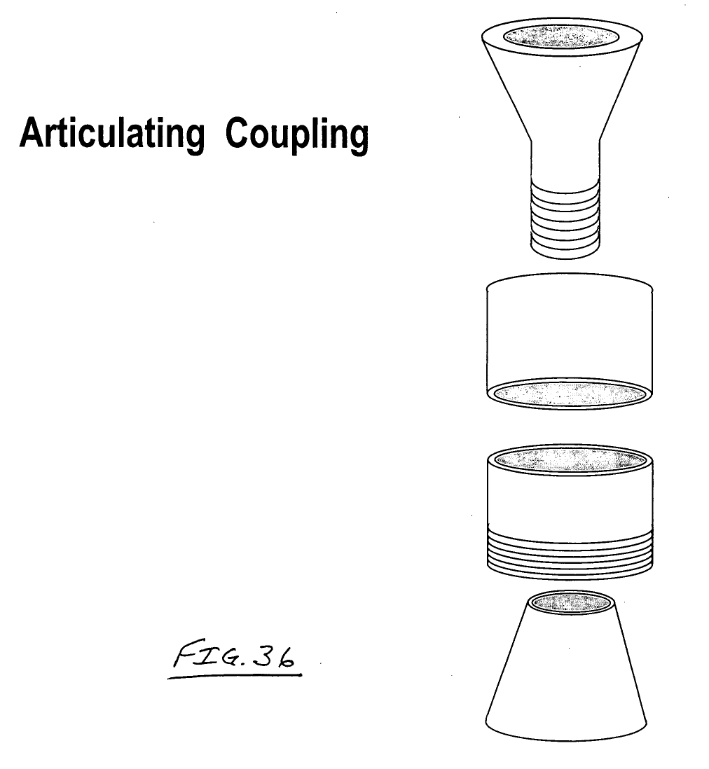

FIG. 35 is a perspective view of another preferred embodiment of the gang/junction box apparatus of the present invention.

FIG. 36 is a perspective, break-away view of a preferred embodiment of the articulating coupling apparatus of the present invention.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

What is claimed is:

1. A connector comprising:
(a) a first element for accepting an electrical conduit, the first element comprising
(1) a first member for accepting electrical terminals,
(2) a second member for removeably engaging the first member such that a wire is can in electrical communication with the electrical terminals when the members are engaged,
(3) a threaded adapter fixedly secured to the second member for receiving the electrical conduit for securing the wire, the electrical conduit having threads matching the threads in the adapter for securing the conduit to the threaded adapter, and
(b) a second element for removeably engaging the first element such that the elements can be engaged and disengaged for providing electrical communication there between.

2. A system for providing electrical connectivity comprising:
(a) a connector,
(b) a plurality of wires for remotely engaging the connectors, and
(c) a gang box for receiving the connectors such that the wires can be connected to any electrical appliance by using additional connectors for providing electricity to the appliance.

3. The method of removably making an electrical connection the steps of
(a) accepting an electrical conduit in a first element, the first element comprising
(1) a first member for accepting electrical terminals,
(2) a second member for removeably engaging the first member such that a wire is can in electrical communication with the electrical terminals when the members are engaged,
(3) a threaded adapter fixedly secured to the second member for receiving the electrical conduit for securing the wire, the electrical conduit having threads matching the threads in the adapter for securing the conduit to the threaded adapter, and
(b) removeably engaging the first element with a second element such that the elements can be engaged and disengaged for providing electrical communication there between.
